(19) United States
(12) Patent Application Publication
(10) Pub. No.: US 2011/0176905 A1
(43) Pub. Date: Jul. 21, 2011

(54) IMPLEMENT, A SYSTEM, AND A METHOD FOR THE MANIPULATION OF ELONGATED PIECES

(75) Inventor: Olavi Savolainen, Tampere (FI)

(73) Assignee: Oy Meclift Ltd., Tampere (FI)

(21) Appl. No.: 13/122,073

(22) PCT Filed: Oct. 2, 2009
(86) PCT No.: PCT/FI09/50794

§ 371 Date: Mar. 31, 2011

(30) Foreign Application Priority Data
Oct. 2, 2008 (FI) 20085931

(51) Int. Cl. B66F 9/18; B65D 19/44; B65D 19/38; B66F 9/12

(52) U.S. Cl. 414/800; 187/237

(57) ABSTRACT

An implement for transfer of long pieces. At least two casings are fitted in a frame of the implement. Inside the casings ends of the long pieces bound in a bundle can be inserted. The ends of the pieces are supported to the casings when the piece is lifted, and the casings lift all the pieces with them. Mounting units are fitted in the frame for mounting to a transfer device for moving the implement and for transferring the pieces. A system includes a transfer device, on which the implement is mounted; and at least one bundle of long pieces bound to each other. Placement, shape and dimensions of the pieces substantially corresponds to placement, shape and dimensions of the casings such that the ends of the pieces can be inserted into the casings of the implement for the transfer of the bundle. A method includes transferring the implement with a transfer device such that the ends of the long pieces, separate or bound in a bundle, are transferred into the casings of the implement, but the pieces are otherwise left outside the casing.

### FIELD OF THE INVENTION

The invention relates to an implement for the transfer of long pieces. The invention relates to a system for the transfer of long pieces. The invention relates to a method for the transfer of long pieces.

### BACKGROUND OF THE INVENTION

It is known that the manipulation of long pieces whose length is many times, or at least 10 times their diameter or thickness dimension, is difficult.

The most common way to manipulate long pieces is to place them crosswise, for example, on the forks of forklifts. The forks or corresponding means of transport are placed, for example, in a carriage moving up and down along the mast of the forklift. However, a drawback is in this case that the aisle width required by the forklift is multiplied, and the manipulation of long pieces is not possible in narrow aisles. Long pieces can also be placed in a cassette or on a pallet, but in this case, the long pieces are placed across the direction of motion, and the transfer requires a lot of space.

Forklifts are known, whose mast or forks can be turned sideways, so that long pieces can be transferred on the side of the forklift, in the direction of motion of the forklift. Forklifts are also known, in which the forks or corresponding supporting means are always directed to the side and the load can, in many cases, also be transferred from the side of the forklift to the support of the frame of the forklift, or above the same, for example by means of a movable mast. Long pieces extend in the direction of motion of the forklift. The above-mentioned forklifts are, however, specially equipped and more expensive than regular multi-purpose forklifts or corresponding transfer devices, so that their occasional use is not well-founded.

It is also problematic to use the above-described side-loading forklifts for loading long pieces into transport containers, because the forklift always requires space along the side of the pieces. For this reason, loading a transport container fully wall-to-wall is not possible by means of such forklifts, and it may also occur that they do not even fit in the container. Loading a transport container with a conventional forklift is not possible either, because the forklift would require space to align the long pieces in the longitudinal direction of the transport container. On top of it all, the door opening in a transport container is transversely at the narrow end of the transport container, so that an long piece does not even fit in the door opening.

### SUMMARY OF THE INVENTION

An implement for the transfer of long pieces according to the invention is presented in claim 1. A system for the transfer of long pieces according to the invention is presented in claim 5. A method for the transfer of long pieces according to the invention is presented in claim 7.

The aim is to construct an implement that is suitable for use with a conventional, very common forklift. The implement can be mounted on a forklift or another corresponding movable transfer device, on which the implement can be mounted. The means for mounting the implement are preferably universal and such that the implement can be mounted in place of forks on the carriage of a forklift or another transfer device, by using those mounting means of the carriage, to which the forks are also mounted.

The implement is used for manipulating bundles of long pieces, and the implement is used to grip the end of the bundle, wherein the pieces always extend in the direction of motion of the forklift. Thanks to said feature, the forklift can also be used for loading transfer containers, because the implement can now be used for transferring a bundle in the longitudinal direction in through the door opening at the end of the transport container and also for placing bundles side by side, wall to wall.

The implement can be inserted into the end of the bundle in such a way that the ends of single pieces are received in casings, in which the end of the piece is held by friction. Only the ends of the pieces are placed inside the implement, and the bundle is transferred in such a way that the pieces, as a uniform bundle, hang out of the implement. The implement is dimensioned so that it is capable of supporting a given number of pieces, taking into account the weight of the pieces and the loadings. The length of the pieces must not be arbitrary, because the piece has to be capable of carrying its own weight, as part of the piece extends as a cantilever at a distance away from the implement.

### BRIEF DESCRIPTION OF THE DRAWINGS

In the following, the invention will be described in more detail with reference to an example and simultaneously the appended drawings.

FIG. 1 shows an implement according to the invention in a front view,

FIG. 2 shows an implement according to the invention in a top view,

FIG. 3 shows an implement according to the invention in a side view and in a cross-section along the line A-A of FIG. 1,

FIG. 4 shows a spacer piece that is utilized in a bundle comprising long pieces, and

FIG. 5 shows a bundle comprising several long pieces and its manipulation by means of an implement according to the invention.

### DETAILED DESCRIPTION OF THE INVENTION

An implement 1 comprises a framework that is preferably made of steel and steel sheets. In the presented example, the framework is rectangular, but it may also have a different shape. The framework according to the example comprises a vertical rear wall 9 and two vertical side walls 6, as well as a horizontal bottom wall 8 and a horizontal top 5. In the framework, pieces can be placed in a matrix of preferably at least 2×2 but normally 4×4, comprising 16 casings 2 for long pieces. Between the casings 2 on top of each other, there is a partition wall 4 that reinforces the structure and is mounted on both sides to the framework, in this case both side walls 6. The partition walls 4 are made of steel, and they transfer loading forces to the framework and elsewhere.

The number of casings may also vary in such a way that the number of casings 2 is different in the horizontal and vertical directions. It is also possible to have only one layer in the horizontal direction, so that there are two or more pieces next to each other. In this way, it is possible to manipulate, for example, low bundles or separate pieces next to each other. It is also possible to manipulate a narrow bundle or separate pieces on top of each other simultaneously. However, there is a whole series of casings 2, comprising at least two casings.

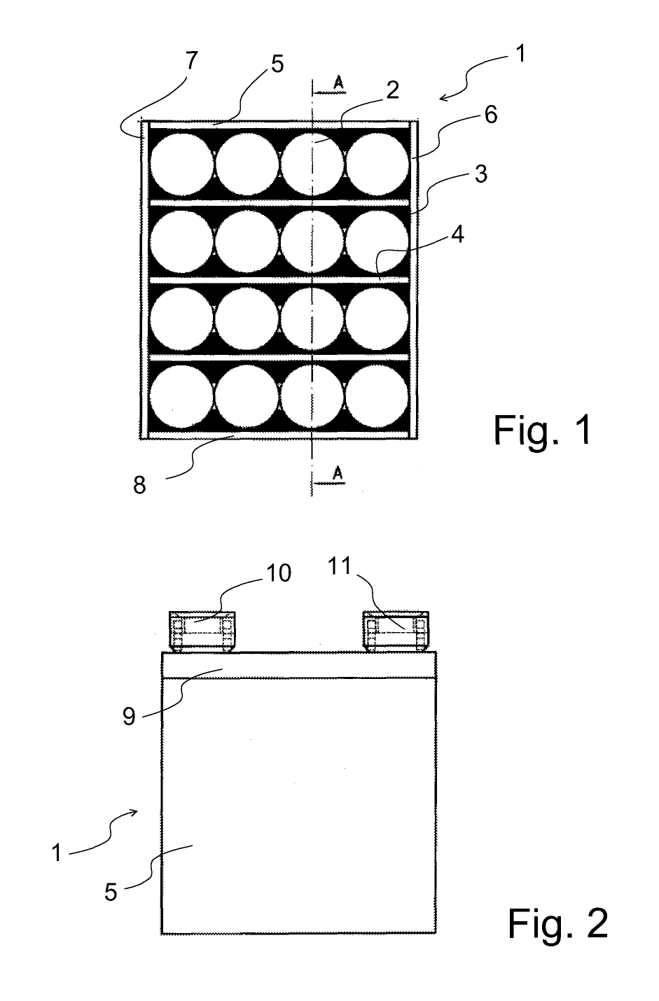

The shape of the casings 2 corresponds to the shape of the pieces to be transferred, which is, in this case, cylindrical. The implement 1 of FIG. 1 can be used for transferring cylindrical pieces which may also be hollow, for example material bars, half-finished bars, tubes, or cylindrical pieces. The end of the piece is placed inside the casing 2, and the casing 2 encircles the piece as completely as possible, or at least from above and below the piece, for example in a sector area covering a range of 120° to 150°. In the lateral direction, the pieces may touch each other or be very close to each other. The pieces on top of each other are spaced from each other by structures of two casings 2 on top of each other (two form pieces 3) and a partition wall 4.

Upon forming a bundle of long pieces 13 as shown in FIG. 5, spacer pieces 14 keep the pieces on top of each other at said distance from each other. Said spacer pieces 14 are used to keep the pieces also horizontally at such a distance from each other that corresponds to the distance between the casings 2. A spacer piece 13 can also be placed underneath the bundle. The placement of the pieces 13 in the bundle corresponds to the placement of casings in the implement 1, in this case a 4×4 matrix.

The cross-sectional shape of the pieces may also be triangular, square, rectangular, or, when it comprises more than four sides, it is possibly also hollow. Even in these cases, the aim is to support the piece from several sides to prevent swinging. However, the piece is always supported both from the upper surface, at least by means of the rear part of the casing 2 close to the end of the piece, and from the lower surface, at least at the front part of the casing 2, at a distance from the end of the piece. In said points, the piece is particularly supported to the casing 2, as the piece 13 hangs out of the implement 1, as shown in FIG. 5.

The shape of the casing 2 corresponds to the shape of the long piece with as little clearance as possible, to support the piece to a contact surface that is as large as possible, between the piece and the form piece 3 forming the casing 2. The mouth of the casing 2 may be provided with an expansion or an inclined collar to guide the piece into the casing 2. The length or depth of the casing 2 is typically about 800 to 1200 mm, preferably 1000 mm, and the diameter of the casing is, in this example, typically about 200 to 300 mm, preferably 250 mm. The length of the piece 13 is typically at least 2.5 m, preferably at least 3 m, and even greater than 6 m.

The form piece 3 comprises at least one but preferably several and, in this example, four pieces with a concave shape corresponding to the shape of the outer surface of the piece. The form piece 3 covers part, typically less than half, of the periphery of the outer surface of the piece. One form piece 3 is provided above and one underneath the piece, and they are supported either to the partition wall 4, the bottom wall 8, or the top 5. The form piece is preferably made of plastic that does not damage or scratch the piece.

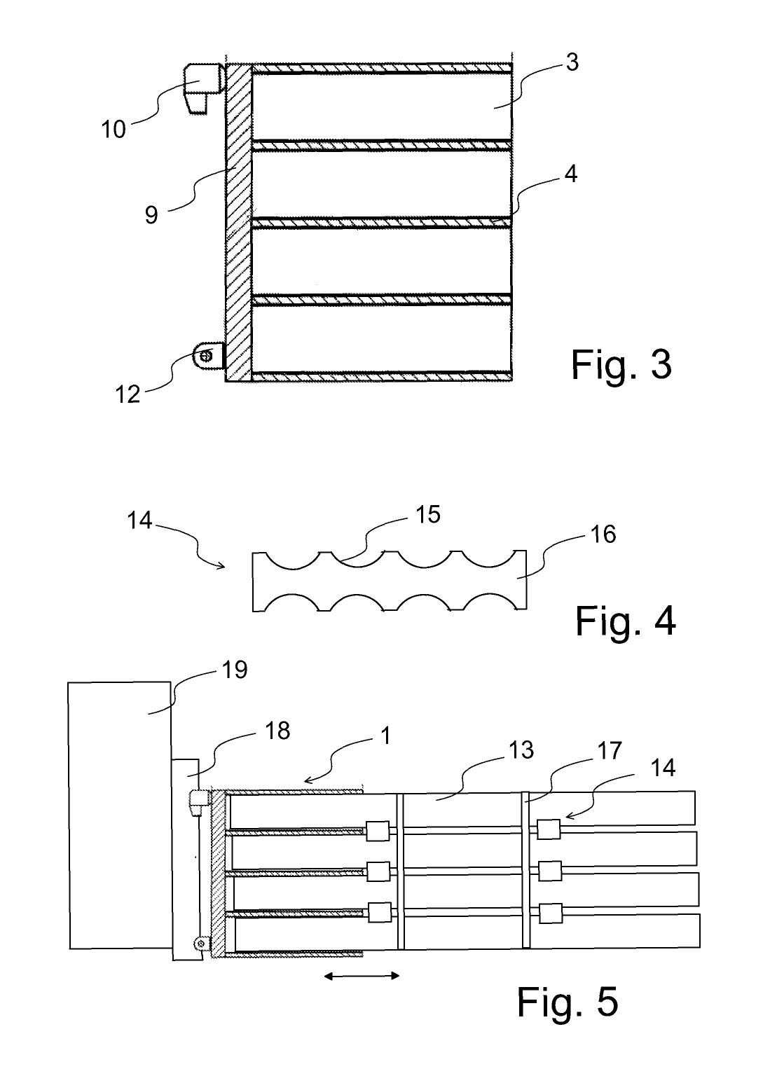

FIGS. 2 and 3 show upper mounting means 10, 11 and a lower mounting means 12 mounted to the framework, in this example the rear wall 9, which have a universal structure according to prior art known as such, to make the mounting of the implement 1 to the transfer carriage 18 of a forklift or another transfer device 19 possible, as shown in FIG. 5. The transfer carriage 18 has at least a vertical transfer movement and typically also a tilting forward and backward. Some forklifts and transfer devices have also a transverse transfer movement of the transfer carriage 18.

FIG. 5 shows, in more detail, a bundle formed of pieces 13, wherein the placement and dimensions of the pieces 13 correspond to the placement and dimensions of the casings 2 of the implement 1. Typically, a certain type of implement is provided for certain types of pieces, and a bundle is made to match with the dimensions of the implement. Thus, spacer pieces 14 are utilized, whose frame 16 comprises both parallel and concave profiles 15 to be placed on the upper and lower surfaces of the frame 16 to keep the pieces 13 in place and to be placed between the pieces 13. The dimensions of the spacer piece 14 corresponds to the dimensions of the implement 1, for the necessary parts. The material of the spacer pieces 14 is, for example, wood or plastic. The bundle is also bound by bandages or strips 17. The distance of the spacer pieces 14 and the strips 17 from the end of the piece 13 is greater than the depth of the casing 2.

The implement 1 is used by pushing the implement 1 into a stationary bundle in such a way that the ends of the pieces 13 slide as deep into the casings 2 as possible. The implement 1 is elevated, and as the ends of the pieces 13 remain in place in the casings 2, the whole bundle is simultaneously elevated. It is now possible to transfer the bundle by the forklift or transfer device 19 in the longitudinal direction of the pieces and to load it, for example, into a transport container. The implement is unloaded by lowering the implement, wherein the bundle is placed onto the ground or a floor, supported by its own weight, and the implement can be freely pulled out from the end of the bundle. The casings 2 and the pieces 13 are substantially horizontal during the transfers and when the ends of the pieces 13 are inserted into the casings 2.

The invention is not limited solely to the example presented above, but it may vary within the scope of the appended claims.

1. An implement for the transfer of long pieces, the implement comprising:
at least two casings fitted in a frame of the implement, inside which casings ends of the long pieces, separate or bound into a bundle, can be inserted, wherein the ends of said pieces are supported to the casings when the piece is lifted, and the casings lift all the pieces with them; and
a mounting elements fitted in the frame for mounting to a transfer device, for moving the implement and for transferring the pieces.

2. The implement according to claim 1, further comprising:
at least two form pieces made of a plastic material, placed above and below each casing and piece, and supported to the frame, as well as comprising an open concave shape that corresponds to a profile of the piece to be transferred by the implement, wherein each form piece has at least one concave profile.

3. The implement according to claim 2, wherein the frame of the implement is made of steel, the implement further comprising:
at least one horizontal partition wall made of steel and connected to the frame, is placed between the casings and the form pieces on top of each other, and to which said form pieces are supported.

4. The implement according to claim 1, wherein the casings of the implement form a matrix, in which the placement, shape and dimension of the casings correspond to the placement, shape and dimension of the pieces of the bundle to be transferred by the implement, but in such a way that only the ends of the pieces are placed in the casings during the transfers.

5. A system for the transfer of long pieces, the system comprising:
an implement comprising a frame and at least two casings fitted in the frame of the implement, inside which casings ends of the long pieces bound in a bundle can be inserted, wherein the ends of said pieces are supported to the casings when the piece is lifted, and the casings lift all the pieces with them; and mounting units fitted in the frame for mounting to a transfer device, for moving the implement and for transferring the pieces;
transfer device, on which the implement is mounted; and
at least one bundle of long pieces bound to each other, a placement, shape and dimensions of the pieces substantially corresponding to a placement, shape and dimensions of the casings of the implement, in such a way that the ends of said pieces can be inserted into the casings of the implement for the transfer of the bundle.

6. The system according to claim 5, wherein the bundle comprises:
at least one spacer piece that is placed between the long pieces on top of each other and comprises at least two open concave profiles which are placed on a lower surface and an upper surface of the spacer piece and which correspond to a shape of said pieces.

7. A method in transfer of long pieces, the method comprising:
transferring an implement with a transfer device in such a way that ends of the long pieces, separate or bound in a bundle, are transferred into casings of the implement, but the pieces are otherwise left outside the casing;
lifting the pieces by elevating the implement, wherein the pieces hang out of the implement, the ends of the pieces being supported to the casings;
performing the transfer of the separate pieces or the bundle; and
releasing the pieces separately or the bundle by lowering the bundle onto a floor or onto a ground and pulling the implement off the pieces separately or the bundle, wherein the ends of said pieces slide out of the casings.

8. The method according to claim 7, further comprising:
placing at least one spacer piece into the bundle, the spacer piece being placed between the long pieces on top of each other and comprising at least two open concave shapes which are placed on a lower surface and an upper surface of the spacer piece and which correspond to the shape of said pieces.
